(19) United States
(12) Patent Application Publication
(10) Pub. No.: US 2004/0075893 A1
(43) Pub. Date: Apr. 22, 2004

(54) Ultraviolet radiation blocking coating system

(76) Inventor: Lester Cornelius, Oyster Bay, NY (US)

Correspondence Address: Charles E. Temko, 22 Marion Road, Westport, CT, 06880, US

(21) Appl. No.: 10/671,693

(22) Filed: Sep. 29, 2003

Related U.S. Application Data
(63) Continuation-in-part of application No. 09/849,884, filed on May 4, 2001, now abandoned.
(60) Provisional application No. 60/220,173, filed on Jul. 24, 2000.

(51) Int. Cl. G02B 5/20

(52) U.S. Cl. 359/361; 359/359

(57) ABSTRACT

A two-layer resin coating system for protecting surfaces against ultraviolet light. An inner layer includes both an ultraviolet absorber and an optical brightener. An outer layer includes sufficient ultraviolet absorptive material to prevent transmissions sufficient to cause the optical brightener in the inner layer to glow or reflect light which is perceived as yellow.

### RELATED APPLICATION

Reference is made to my co-pending non-provisional application for letters patent, Serial No.: 089/849,884, filed May 4, 2001, to which a claim of priority is made.

### BACKGROUND OF THE INVENTION

Ultraviolet radiation is composed of three ranges, namely: UVA, which is from 320 to 400 nanometers, UVB which is from 280 to 320 nanometers, and UVC which is from 100 to 280 nanometers. UVA and UVB are attenuated by the atmosphere, but it still reaches the earth's surface. UVC is usually blocked by the ozone in the atmosphere. Man-made lighting sources also produce ultraviolet radiation. Most fluorescent lighting has a high output in the UVA range. UVB causes more damage than UVA, but all ultraviolet radiation will cause degradation to materials.

Ultraviolet rays from the sun, or from man-made sources, degrade many materials by breaking their molecular bonds. Dyes and inks fade from ultraviolet, plastics lose their properties, paints chalk and fade, and many other items are damaged. Strategies to combat ultraviolet degradation include the use of materials that absorb ultraviolet radiation and convert it to heat energy. Most absorbers have an ultraviolet cutoff of 365 nanometers. A few have higher cutoffs, up to 384 nanometers with little to no yellowing. The phenomenon of producing a yellow cast when absorbers are used to block all of the ultraviolet radiation is due to the gradual slope of the absorption curve of the absorbing material. This slope, when the cutoff is extended to 400 nanometers, causes absorption of violet and blue light. The absence of blue light is perceived as yellow, and it is for this reason that most absorbers, especially in clear overcoatings, are not used to block all of the ultraviolet radiation up to 400 nm.

The optical density of a filter, an absorber, or a coating, to a range of radiation is directly related to the concentration and thickness of the layer. The thinner the layer, the higher the concentration of absorber is required. Very thin coating layers, below 10 microns cannot contain sufficient levels of absorbers without a significant loss in the properties of the coating material. As an example, a 4 micron clear coating might require thirty percent, by weight, of an absorber to have complete absorption up to the cutoff wavelength of the absorber. Some common classes of ultraviolet absorbers are benzophenones and benzotriazoles.

As described in U.S. Pat. No. 6,166,852, granted Dec. 26, 2000, it is known in the art to use so-called optical brighteners in combination with ultraviolet absorbing materials to absorb or reflect substantially the UVA spectrum using a multilayered film which lends itself for use as an applied control for windows of a building.

A coating layer that is effective in blocking ultraviolet and is thin has the additional advantage of lower material cost and higher degree of possible flexibility. A coating with a low concentration of absorber, so that the physical properties of the coating layer are not diminished, as well as the lower cost of using less absorber, that blocks all ultraviolet up to 400 nm, and does not have a significant effect on blue light absorption would be a significant improvement in the effort to stop ultraviolet damage to materials.

### SUMMARY OF THE INVENTION

The disclosed coating system blocks ultraviolet radiation up to and including 400 nanometers, the upper end of ultra violet light. Preventing ultraviolet (uv) radiation from reaching materials and surfaces greatly improves weatherability and resistance to physical degradation from the effects of uv radiation on chemical bonds. There currently exist many types of ultra violet inhibitors which are meant to be included in materials to improve their resistance to uv radiation. The damage from uv radiation is greater as the wavelengths of uv become shorter. However, considerable damage still occurs from the longer wavelengths of uv radiation. It is desirable to block the uv radiation and not have yellowing effect. The disclosed coating system remains water white, and is effectively sufficiently thin, so as to be applicable to a variety of protected surfaces. It includes an outer coating in the 3-4 micron thickness range having an ultraviolet absorber, and an inner coating having both a substantially larger quantity of uv absorber and an optical brightener, wherein the ultraviolet absorber in the outer coating controls the reflection of the optical brightener, and the ultraviolet absorber in the inner coating substantially protects the surface to which it is applied.

### DETAILED DESCRIPTION OF THE DISCLOSED EMBODIMENTS

In accordance with the invention, the disclosed coating system is a two-layered system using a typical ultraviolet absorber in its inner layer (called the blocking layer), furthest away from the source of ultraviolet exposure, with a fluorescent material which reflects ultraviolet radiation back as blue light. The ultraviolet absorber in the inner layer is used in sufficient concentration to have an ultraviolet cutoff which can be extended with the fluorescent material. There are natural fluorescent materials such as calcite, willemite, esperite, fluorite, and diamonds. There are also man-made fluorescent materials used to make materials look whiter by reflecting the longewave ultraviolet radiation as blue light. These are called optical brighteners. Typical optical brighteners are disuphonates, tetrasulphonates, and hexasulphonates. These are water soluble optical brighteners. An example of a solvent soluble optical brightener is UVITEX OB from Ciba-Geigy Corp., which is understood to be 2.5 Bis(5-Tert-Butyl-2-Benzoxoazolyl)Throphene.

Such optical brighteners are typically used in textiles at very low concentrations of less than one percent by weight. Their purpose is to reduce the yellowness of a material, dye, plastic, etc. The present invention provides the desired protection by combining an optical brightener with an ultraviolet radiation absorber in a single inner layer which raises the cutoff wave length and increases blue light, rather than absorbing blue light as a longer wave length cutoff ultraviolet absorber would normally do. A second overlying layer contains a substantially reduced level of ultraviolet absorbing material.

This barrier requires high levels of optical brightener to convert the longer wavelength ultraviolet radiation into blue light and do this effectively enough to block the transmission from the outer layer to the inner layer due to the total conversion of longer wavelength ultraviolet to blue light. The high level of optical brightener causes a significant fluorescent effect upon exposure to ultraviolet radiation, where this layer will glow with blue light.

The surface of the inner or blocking layer also has a significant quantity of fluorescent material which is not protected in depth by the included ultraviolet absorber. This is the primary reason the outer coating layer is effective in reducing fluorescence and why it is necessary. The fluorescent material in the inner layer that lies in the matrix of resin and ultraviolet absorber is then protected from excessive fluorescent excitation. Another technique is to use an alkaline material in the outer coating to decompose the surface of the optical brightener of the blocking layer. Still another technique to reduce surface fluorescence is to use an optical brightener Quencher such as OBA Quencher from Kalamazoo Paper Chemicals Corp.

Stated differently, while a single blocking layer can be used for protection against ultraviolet, the fluorescent blue glow is generally undesirable. In order to significantly reduce this fluorescence, it is necessary to reduce the amount of ultraviolet that reaches this layer in the peak wavelengths for fluorescence. This is done by applying an overcoating to the blocking layer which contains some level of ultraviolet absorber that reduces the ultraviolet transmission of the wavelengths that cause fluorescence. It is then this combined effect and balance which completely blocks ultraviolet radiation without yellowing.

The outer coating can provide other properties such as chemical resistance, scratch resistance, slip, or friction. The outer coating material can be any resin system with an ultraviolet inhibitor, but it is preferably clear and relatively ultraviolet transparent. Materials that do not absorb ultraviolet on their own are relatively unaffected by exposure to it. For this reason, typical outer coating resins would be aliphatic urethanes, polysiloxanes, or acrylics.

Fluorescent materials have been used in many applications to “whiten” whites, or brighten colors in many products. The technique is to use the fluorescent material to increase the reflected blue light. The increase in blue light is perceived as a reduction in yellow light from the fluorescent material. It typically takes very small quantities of fluorescent material to accomplish this brightening effect.

Uv absorbers are widely available and are commonly used with the intention of blocking primarily UVB. When these uv absorbers are used to block all uv light, they increase yellow light perception due to the reduction in blue light.

Higher concentrations of fluorescent materials in a single layer coating will cause a blue fluorescent glow to the material when it is exposed to uv light. This is cosmetically objectionable. For this reason, only low concentrations are used for brightening.

Blocking uv from reaching the surface of an object is a function of film thickness and concentration. Thin films down to 3-5 microns would require very high concentrations of uv absorbers to have complete blocking power. These thin films, such as those in polysiloxane abrasion resistant coatings, would need uv absorber concentrations as high as 30 percent to accomplish an optimal absorption based on the uv absorber. At that concentration, the properties of the coating are drastically degraded.

The inside layer of the present system can be in a range of 6 microns or higher, using Uvitex OB (Ciba-Geigy), with 9-15 microns being optimum. This range is based on the maximum solubility of the uv absorber and the fluorescent material. If other uv absorbers and fluorescent materials are chosen, this film thickness range can be adjusted accordingly.

The second or outer coat, in order to maintain flexibility, must be in the 3-4 microns range film thickness depending on the brittleness of the resin system. In order to maintain the properties of the outer coat at this film thickness, it is necessary to keep the uv absorber in this layer at the maximum level before degradation of the coating's physical properties occurs.

In accordance with the invention, the disclosed system includes an outer coating which also has a uv absorber to prevent the blue glow at the inner surface of an inner layer. This blue glow will appear hazy prior to application of the outer coating.

UVA absorbers that block all uv up to 400 nm tend to be significantly yellow in color. This is because of their absorption curve. The more gradual the slope of the curve the more visible blue and violet light is absorbed which is then perceived as yellow. It is desirable when blocking uv up to 400 nm to have a very steep transmission curve with a transmission cutoff of at 400 nm to avoid the yellowing effect.

Degradation due to outdoor exposure also occurs from pollutants which are carried to the item via precipitation and air. These pollutants are typically oxides and various dilute acids such as acid rain. The pollutants can cause colorants to fade as the molecular bonds are broken. It is desirable to have protection against this type of chemical breakdown such as a chemically resistant barrier.

Certain items, such as printed paper, can also be damaged by precipitation such as rain and snow which, in the form of water, causes the paper to deteriorate and some print materials such as an ink to bleed. It is therefore desirable to create a barrier to precipitation for good outdoor weatherability.

There currently exist coatings and laminations which are partial uv blockers and which are transparent but have poor abrasion resistance, such as vinyl coatings and laminates. It is desirable to have good abrasion resistance in a product to be used outdoors to prevent changes in gloss levels from abrasion which might be caused by wind borne debris or cleaning.

The current practice of including uv absorbers in the body of plastic items, or in overcoatings is often of limited effectiveness because it is weakened by the relationship of film thickness and concentration of uv absorber. The thicker the coating the lower the concentration of uv blocker necessary. Thin coatings are often desirable due to cost and flexibility. When a uv absorber is included in a colored molded item, the surface has the lowest concentration of uv absorber and so this surface degrades quicker than the material behind this surface. Thus, even though the colored material contains uv absorber, its relative concentration at the surface of the item is low, so the color fades at the surface. With suitable coating the weatherability of a molded plastic item is improved in terms of physical properties except for a significant improvement in color fade, as this is a surface effect. The bulk of the material has protection in depth.

The best combination of protection against color fade is to include pigments which are resistant to uv degradation along with uv inhibitors. In the inkjet industry it is common to combine uv resistant inks with a uv inhibited outer laminate for further protection against fading in applications where long term exposure to uv is expected.

Solvent selection requires compatibility with the resin systems and additives, leveling characteristics, and the prevention of crystallization of the additives. The following examples are illustrative.

### EXAMPLE 1

Inner Coating
Ratios are based on weight
Solvents are used to dilute this coating
formulation to achieve a 9-10 micron
film thickness for this example. Various surfactants are used for leveling.

| | |
|---|---|
| Acryloid A 21 - (Rohm & Haas) | 84.03% by weight total solids |
| Uvitex OB (Ciba-Geigy) | 9.24% by weight total solids |
| Tinuvin 328 (Ciba Geigy) | 6.73% by weight total solids |

Outer Coating
The second coating is the outer layer coating
which should be 3-4 microns in
this example. Solvents are used to dilute the
solids to achieve the desired film
thickness. Various catalysts and leveling agents
are used to cure and level the
coating.

| | |
|---|---|
| GR 653 polysiloxane resin (Techneglas) | 97% by weight of total solids |
| Tinuvin 328 (Ciba Geigy) | 3% by weight of total solids |

### EXAMPLE 2

Inner Coating

| | |
|---|---|
| Acryloid A 21 - (Rohm & Haas) | 84.03% weight solids |
| Uvitex OB (Ciba-Geigy) | 9.24% weight solids |
| Tinuvin 328 (Ciba Geigy) | 6.73% weight solids |

### EXAMPLE 2

Outer Coating

| | |
|---|---|
| Desmodur N - 75 (Bayer) | 34.88% weight solids |
| Desmophen 670A - 80 (Bayer) | 62.02% weight solids |
| Dibutyltindilaurate (Pfaltz & Bauer) | 0.1% weight solids |
| Tinuvin 328 (Ciba Geigy) | 3.0% weight solids |

### EXAMPLE 3

Inner Coating
Water is the diluent for this coating formulation.
Various surfactants and leveling
agents are used to improve adhesion and leveling.

| | |
|---|---|
| Johncryl 537 (Johnson's Wax) | 77.52% weight solids |
| Uvinul D 40 (Basf Wyndotte) | 6.2% by weight solids |
| Triethanolamine (Pfaltz & Bauer) | 7.75% by weight liquid |
| OBA Quencher (Kalamazoo Chemical) | 8.53% weight solids |

Outer Coating

| | |
|---|---|
| SHC 4000 (General Electric) | 97% weight solids |
| Tinuvin 328 (Ciba Geigy) | 3% weight solids |

The outer coatings provide desired physical properties and they provide quenching of the optical brightener at the surface of the inside layer. This quenching is accomplished by uv transmission reduction by the top=coating and/or by adding a higher pH material to the outer coating which quenches the optical brightener.

Some typical applications are store front display window to protect the items on display from ultraviolet damage, protection of inkjet prints which are very susceptible to ultraviolet degradation, plastic sheeting which degrades and turns yellow in outdoor applications, works of art which are subject to man-made ultraviolet radiation, and, in general, any item that is damaged by ultraviolet radiation. In order to achieve weatherability of inkjet prints which may be used for signs, posters, billboards, etc., it is often necessary to laminate them with films that provide protection against ultraviolet radiation.

In another embodiment, a thin layer of polyester film is coated on one surface with the blocking layer and the second coating is applied to the opposite surface. The film is provided with a suitable laminating adhesive, such as heat-activated vinyl, EVA, and similar adhesives. The film may be applied to an inkjet print on the printed side. This embodiment of the coating systems forms a thin flexible transparent tear resistant laminate which blocks out ultraviolet to less than one percent transmission at 400 nm and to less than 0.1% transmission below 400 nm down to 280 nm. The polysiloxane coating also provides scratch resistance, as well as chemical resistance.

By providing a two-layer system, rather than a single layer system, it is possible to have the inner layer absorb the bulk of received ultraviolet radiation, and reflect radiation above 375 nm as blue light, so that the coating is seen as clear rather than as a yellow tint.

In the disclosed examples, the ratio of ultraviolet absorber in the outer coating relative to the inner coating is approximately 1 to 5.33. This may be varied depending upon the relative thickness of the inner and outer coatings. It will be understood that it is desirable to have both inner and outer coatings having the maximum amounts of ultraviolet absorber constituents consistent with maintaining physical characteristics of the particular resin used. In each case, the ultraviolet absorber in the outer coating is essentially transparent, and provides sufficient uv blocking to suppress the glow which would otherwise occur in the optical brightener component of the inner coating. The bulk of the ultraviolet protection is provided by the larger amount of ultraviolet absorber in the inner coating.

Most conveniently, both layers are applied using known spraying techniques in serial fashion, which lends itself to the application of both layers upon a thin polyester film, and the like. Other methods are possible, including dipping, flow-coating, curtain coating or by any other liquid application method.

I wish it to be understood that I do not consider the invention to be limited to the precise details and examples described hereinabove, for obvious modifications will occur to those skilled in the art to which the invention pertains.

I claim:

1. An ultraviolet radiation absorbing coating system comprising a first inner synthetic resinous layer having an ultraviolet radiation absorber having an ultraviolet cutoff lower than about 385 nanometers, and a fluorescent material which reflects ultraviolet radiation of wave length above 385 nanometers; and a second outer layer overlying said first inner layer and having an ultraviolet radiation absorbent material which blocks at least some ultraviolet radiation of wavelength above 385 nm to reduce reflection in said fluorescent material.

2. A system in accordance with claim 1, in which said first and second layers are applied to oppositely disposed surfaces of a synthetic resinous film.

3. A system in accordance with claim 2, in which said film includes an adhesive on an exposed surface of said first layer for application to a printed surface of a protected substrate.

4. An ultraviolet absorbing coating system in accordance with claim 1, including first and second inner and outer coatings of the following formulation.
Inner Coating
Ratios are based on weight
Solvents are used to dilute this coating
formulation to achieve a 9-10 micron
film thickness for this example. Various surfactants are used for leveling.

| | |
|---|---|
| Acryloid A 21 - (Rohm & Haas) | 84.03% by weight total solids |
| Uvitex OB (Ciba-Geigy) | 9.24% by weight total solids |
| Tinuvin 328 (Ciba Geigy) | 6.73% by weight total solids |

Outer Coating
The second coating is the outer layer coating which
should be 3-4 microns in
this example. Solvents are used to dilute the solids
to achieve the desired film
thickness. Various catalysts and leveling agents are
used to cure and level the
coating.

| | |
|---|---|
| GR 653 polysiloxane resin (Techneglas) | 97% by weight of total solids |
| Tinuvin 328 (Ciba Geigy) | 3% by weight of total solids |

5. An ultraviolet absorbing coating system in accordance with claim 1, including first and second inner and outer coatings of the following formulation. Parts are by weight of solids.
Inner Coating

| | |
|---|---|
| Acryloid A 21 - (Rohm & Haas) | 84.03% weight solids |
| Uvitex OB (Ciba-Geigy) | 9.24% weight solids |
| Tinuvin 328 (Ciba Geigy) | 6.73% weight solids |

Outer Coating

| | |
|---|---|
| Desmodur N - 75 (Bayer) | 34.88% weight solids |
| Desmophen 670A - 80 (Bayer) | 62.02% weight solids |
| Dibutyltindilaurate (Pfaltz & Bauer) | 0.1% weight solids |
| Tinuvin 328 (Ciba Geigy) | 3.0% weight solids |

6. An Ultraviolet absorbing coating system in accordance with claim 1, said first and second coatings having the following formulation:
Inner Coating

| | | |
|---|---|---|
| Johncryl 537 (Johnson's Wax) | 77.52% | weight solids |
| Uvinul D 40 (Basf Wyndotte) | 6.2% | by weight solids |
| Triethanolamine (Pfaltz & Bauer) | 7.75% | by weight liquid |
| OBA Quencher (Kalamazoo Chemical) | 8.53% | weight solids |

Water is the diluent for this coating formulation. Various surfactants and leveling agents are used to improve adhesion and leveling.
Outer Coating

| | |
|---|---|
| SHC 4000 (General Electric) | 97% weight solids |
| Tinuvin 328 (Ciba Geigy) | 3% weight solids |
